(19) United States
(12) Patent Application Publication
(10) Pub. No.: US 2008/0187062 A1
(43) Pub. Date: Aug. 7, 2008

(54) METHOD AND APPARATUS FOR MULTIPLE-INPUT MULTIPLE- OUTPUT FEEDBACK GENERATION

(75) Inventors: Kyle Jung-Lin Pan, Smithtown, NY (US); Allan Yingming Tsai, Boonton, NJ (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/027,148

(22) Filed: Feb. 6, 2008

Related U.S. Application Data
(60) Provisional application No. 60/888,329, filed on Feb. 6, 2007.
(60) Provisional application No. 60/888,359, filed on Feb. 6, 2007.

(51) Int. Cl. H04L 27/28; G06F 17/16

(52) U.S. Cl. 375/260; 708/520

(57) ABSTRACT

Disclosed are a method and apparatus for generating feedback in multiple-input/multiple-output (MIMO) communications. Feedback is used to update a precoding matrix

### CROSS REFERENCE TO RELATED APPLICATIONS

This application claims the benefit of U.S. provisional applications No. 60/888,329 filed Feb. 6, 2007 and 60/888,359 filed Feb. 6, 2007, which are incorporated by reference as if fully set forth.

### FIELD OF INVENTION

The present disclosure is related to wireless communications. More particularly, the present disclosure is related to feedback generation in multiple-input multiple-output (MIMO) communication.

### BACKGROUND

In wireless communication, multiple-input multiple output (MIMO) is the use of multiple antennas at both a transmitter and a receiver to improve communication performance. It can offer significant increases in data throughput and link range without additional bandwidth or transmit power. One form of MIMO makes use of precoding. In precoding, multiple signal streams are emitted from the transmit antennas with independent and appropriate weighting of phase, gain, or both such that the signal is optimized at the receiver input.

The Third Generation Partnership Projects (3GPP and 3GPP2) are considering long term evolution for radio interface and network architecture. Efficient feedback is needed for closed-loop MIMO communication including precoding.

### SUMMARY

A method and apparatus are disclosed for generating feedback in multiple-input/multiple-output (MIMO) communications. An update to a precoding matrix which optimizes a received signal is determined, and the optimized update is transmitted as a single bit.

### BRIEF DESCRIPTION OF THE DRAWINGS

FIG. 1 shows a method of MIMO feedback generation.

FIG. 2 shows an apparatus for MIMO feedback generation.

FIG. 3 shows another embodiment of an apparatus for MIMO feedback generation.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

The following disclosures are to be construed as examples and not as limiting. In particular they are not to be construed as being limited to a particular technology or standard.

Embodiments to be disclosed may be applied to both downlink (DL) and uplink (UL) communications. Embodiments are directed to efficient MIMO feedback for precoding, beamforming, or transmit diversity. A precoding matrix or vector can be updated using a one bit feedback. The generation of such feedback information does not require a dedicated reference signal such as those using precoded pilot or special transmit data patterns such as those using precoded data.

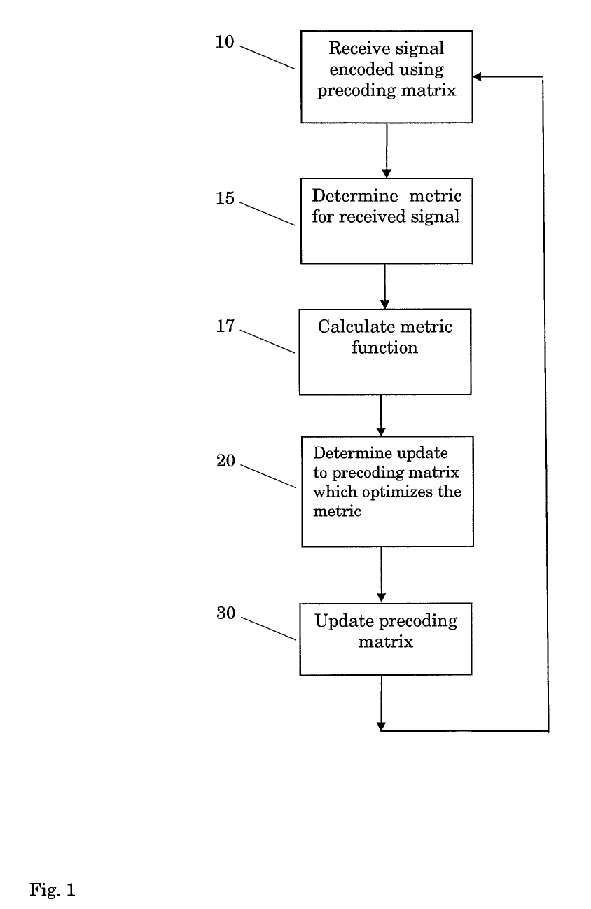

FIG. 1 summarizes a method for MIMO feedback. A signal is received which is encoded using a current precoding matrix 10. Using information contained in the received signal, at least one signal metric is determined 15. The metric may be a measure of signal strength or signal quality and is described in greater detail below. A metric function is calculated from the metric 17. Updating information for the precoding matrix is determined which optimizes the signal metric 20. The updating information is calculated using the metric function. The updating information is used to update the precoding matrix 30 for subsequently received signals 10, thus completing a feedback loop.

The method shown in FIG. 1 can be carried out in the time domain, the frequency domain, or both. At a given time a precoding matrix can be updated in more than one frequency band.

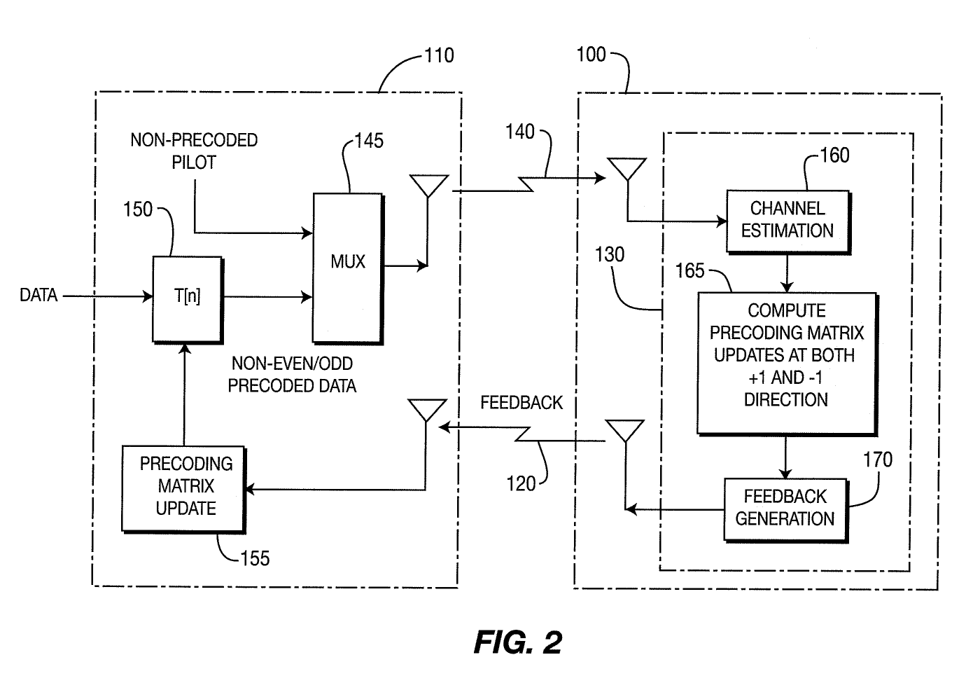

FIG. 2 schematically illustrates an apparatus for a MIMO feedback generation without using precoded pilot or data, in accordance with the method shown in FIG. 1. Referring to FIG. 2, a wireless transmit/receive unit (WTRU) 100 contains a processor 130, which in turn contains channel estimation circuitry 160, computing circuitry 165, and feedback generation circuitry 170. WTRU 100 is in two way communication with a base station 110. Base station 110 contains precoding matrix updating circuitry 155, precoding circuitry 150 and multiplexer 145.

WTRU 100 receives a signal 140 from a base station 110. Estimation circuitry 160 determines a channel matrix H from the received signal 140. The matrix H characterizes the transfer of signals between base station 110 and WTRU 100. Computing circuitry 165 determines possible precoding updates denoted as +1 and −1 using channel matrix H. These update symbols may represent two physical beam directions or other beam forming or shaping characteristics, referred to generically hereafter as “directions”. The +1 and −1 directions thus represent updates to the precoding matrix or vector toward the direction that optimizes the desired metric. Examples of such metric optimization are maximizing a received power, a signal-to-noise ratio, a signal-to-interference ratio, a signal-to-noise and interference ratio (SINR), a channel capacity, or an overall transmission rate. Other examples are minimizing a received interference level, a mean square error (MSE), or a bit error rate (BER). For example if the selection of +1 and −1 direction is made to maximize the total receiver power, the optimal direction could correspond to the direction of the peak of beamforming toward a desired target such as a wireless transmit/receive unit (WTRU). If it is to maximize the SINR, the optimal direction could correspond to a beam shape that points the peak to a desired target and points a null or minimum in transmitted power to a source of interference. The direction may be a physical direction of a beam, a shape of a beam or other characteristics in a beamforming space. A feedback sign bit is generated by generation circuitry 170 based on whichever precoding matrix update optimizes the received signal 140. WTRU 100 sends feedback signal 120, which includes the generated sign bit, to base station 110.

At base station 110 updating circuitry 155 updates the precoding matrix using the generated sign bit and sends the updated matrix to precoding circuitry 150, where incoming data is precoded using the updated precoding matrix. The newly precoded data is multiplexed with a non-precoded pilot in multiplexer 145 and transmitted as a signal 140 to WTRU 100.

Updating circuitry 155 updates the precoding matrix such that the resulting signal transmission 140 from base station 110 approaches the direction which optimizes the signal received at WTRU 100. Examples of this optimization include maximizing a received power, a signal-to-noise ratio, a signal-to-interference ratio, a signal-to-noise-and-interference ratio (SINR), a channel capacity, or a reception rate. Other examples include minimizing a received interference level, a mean square error (MSE), or a bit error rate (BER).

A generic form of precoding matrix update q[n] may be represented by the equation

q[n]=M(H[n]S₁[n])−M(H[n]S₀[n]) (1)

where M( ) represents a metric function appropriate for the desired metric, H is the channel matrix, S₀ and S₁ are matrices representing signal flows, and n indicates a time interval, a frequency interval, a subcarrier, a frequency band, a resource block, a resource block group or any combination of these. In the particular example shown in FIG. 2, S₁[n] may be T⁺[n] and S₀[n] may be T⁻[n], where T⁺[n] and T⁻[n] are the precoding matrices updated with direction of +1 and −1, respectively. In this example the metric may be total received power, and an appropriate metric function M is the Frobenius norm, represented by M(x)=∥x∥_{F}. Then substituting in equation 1 for the particular example of FIG. 2, the generation of the feedback sign bit by generation circuitry 170 may be represented by the equation

s[n]=sign{∥H[n+1]T⁺[n+1]∥_{F}²−∥H[n+1]T⁻[n+1]∥_{F}²} (2)

Norms other than the Frobenius may also be used in this example and with other metrics.
The two updated precoding matrices T⁺[n+1] and T⁻[n+1] may be determined without any precoded pilot or data at even and odd slots or symbols as represented by the equations

T⁺[n+1]=T[n]+v∥T[n]∥U (3)

and

T⁻[n+1]=T[n]−v∥T[n]∥U. (4)

In equations 3 and 4, T[n] is a precoding matrix not yet updated, v is an update step size, and U is a perturbation matrix that is random. The elements of matrix U are, in general, complex numbers and may be generated according to any proper random distribution, such as a Gaussian distribution or a uniform random distribution with a finite mean and variance. Since T⁺[n+1] and T⁻[n+1] are determined at WTRU 100, the precoded pilot or precoded data at base station 110 are not required for generating the feedback bit. Thus there is MIMO feedback generation without need of precoded pilot or data.

In an alternative, more than one set of random matrices is generated at a given time, thus providing additional possible combinations of random matrices and updated precoding matrices. In this alternative, additional bits may be used to signal a particular combination. For example, the random matrix in equation 3 may be U₁ and the random matrix in equation 2 may be U₂ which is distinct from U₁. Together with updated precoding matrices T⁺ and T⁻ there are then four combinations, which may be signaled using two bits. The four possibilities are

T₁⁺[n+1]=T[n]+v∥T[n]∥U₁

T₂⁺[n+1]=T[n]+v∥T[n]∥U₂

T₁⁻[n+1]=T[n]+v∥T[n]∥U₁

and

T₂⁻[n+1]=T[n]+v∥T[n]∥U₂.

One of the four possibilities is selected and signaled and is represented by 2 bits. Matrices T₁⁺, T₂⁺, T₁⁻ T₂⁻ may be used to create effective channel matrices \tilde{H}₁⁺, \tilde{H}₂⁺, \tilde{H}₁⁻, \tilde{H}₂⁻ where

\tilde{H}₁⁺=T₁⁺H,\tilde{H}₂⁺=T₂⁺H,\tilde{H}₁⁻=T₁⁻H,\tilde{H}₂⁻=T₂⁻H

and H is the estimated channel matrix.
The optimizing possibility based on, for example, the metric function

$$M ( \tilde{H} ) = {log}_{2} \text{det} ( {\tilde{H}}^{H} \tilde{H} + \frac{1}{ρ} I )$$

is selected using the equation

$$T = \text{arg} {max}_{{T}_{1}^{+} , {T}_{2}^{+} , {T}_{1}^{-} , {T}_{2}^{-}} {log}_{2} \text{det} ( {\tilde{H}}^{H} \tilde{H} + \frac{1}{ρ} I ) .$$

The selected T in above equation is then represented by 2 bits and is transmitted to WTRU 100.

Other metric functions can also be used.

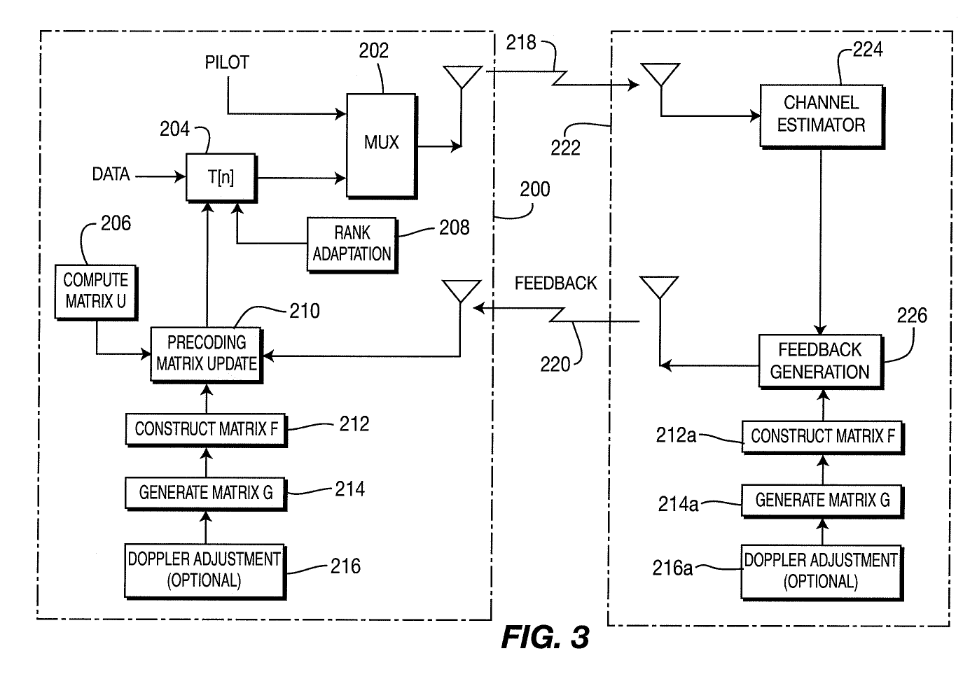

In general for N sets of random matrices there are 2N possibilities. One of the possibilities is selected based on a chosen metric function and the selected possibility is represented by log₂ (2N) bits and fed back to the transmitter from receiver. An alternative embodiment for MIMO feedback apparatus using rank adaptation to select a subset of MIMO channels is shown in FIG. 3. In some situations only a portion or subset of the possible MIMO channels has good enough quality for data transmission. The remaining channels may be, for example, weak in signal strength or have too much interference. Rank adaptation is used to adjust the rank of a MIMO channel based on the channel condition. The rank may be defined as the number of data streams or layers in a MIMO channel that can be used to transmit information at an acceptable or optimal performance.

In the embodiment shown in FIG. 3 the current precoding matrix T[n] and the updated one T[n+1] are considered to be points in a Grassmann manifold or beamforming space. The feedback is based on the idea that a uniform distribution random matrix together with one sign bit can be used to approximate the velocity that takes point T[n] to T[n+1] in Grassmann manifold space in unit time. The point T[n+1] can be reached from point T[n] at time instance n+1 via the curve of shortest length between two points on a Grassmann manifold or beamforming space.

Assume there are Nₜ transmit antennas and Nᵣ receive antennas in a MIMO communication system. Suppose there are Nₛ-dimensional right singular subspaces of a channel matrix H. The selected dominant Nₛ-dimensional eigen-subspaces can be realized by a rank adaptation technique. The selected dominant Nₛ-dimensional eigen-subspaces represent a set of channels with better signal characteristics than the rest of the channels.

Referring to FIG. 3, a transmitter 200 and a receiver 222 communicate with each other. The transmitter 200 may be a base station, such as a Node B, and the receiver 222 may be a user subscriber unit or vice-versa. Receiver 222 receives a precoded signal 218 from transmitter 200. Channel estimation circuitry 224 determines a channel matrix H. Generation circuitry 226 generates a sign bit based on the direction that maximizes or minimizes a predefined metric, as described above.

Receiver 222 sends feedback signal 220, which includes the generated sign bit, to transmitter 200. At transmitter 200 updating circuitry 210 updates the precoding matrix using the generated sign bit and other inputs described below, and sends the updated matrix to precoding circuitry 204. Precoding circuitry 204 also receives rank adaptation information from rank adaptation circuitry 208. Circuitry 208 may receive rank adaptation information from various sources, depending on the particular technology being used. For example, in frequency division duplex (FDD) systems circuitry 208 may take feedback from mobile units that contain rank information. In a time division duplex (TDD) system, where downlink and uplink channels are reciprocal to each other, circuitry 208 may take estimated channel responses measured at base station or Node B as the input and compute a proper rank that represents the number of good channels that can be used for simultaneously transmitting information.

At precoding circuitry 204 incoming data is precoded using the updated precoding matrix. The newly precoded data is multiplexed with a non-precoded pilot in multiplexer 202 and transmitted as a signal 218 to receiver 222, thus completing a feedback loop.

Updating circuitry 210 updates the precoding matrix such that the resulting signal transmission 218 from transmitter 200 approaches the direction which maximizes or minimizes the predefined metric of the signal received at receiver 222. In addition to using the feedback sign bit, updating circuitry 210 computes the updated precoding matrix using a unitary matrix U, generated by circuitry 206, and matrix F, generated by circuitry 212. Matrix F, in turn, is derived from random matrix G which is generated by circuitry 214. Optionally, matrix G may be adjusted with information from optional Doppler adjustment circuitry 216, described further below.

The matrices G and F must also be known by receiver 222. Receiver 222 contains circuitry 212a for generating matrix F, circuitry 214a for generating matrix G and optionally circuitry 216a for providing Doppler information. The same matrix G may be generated in both transmitter 200 and receiver 222 by synchronizing circuitry 214 and circuitry 214a by, for example providing the same random generator seed to both circuitries.

Generation of the feedback sign bit and updating of the precoding matrix may be done using the following procedure. Define an effective channel matrix \tilde{H}, as

\tilde{H}=HT

at time n, where T is a precoding matrix. The received power corresponding to the effective channel is

P=tr(\tilde{H}^{H}\tilde{H})

where the superscript H indicates Hermitean conjugate.

The feedback bit may be generated using a measurement of the effective channel as

b[n]=sign(q[n])

where measure q[n] is an effective channel measurement for the preferred direction that maximizes or minimizes certain metrics. The quantity q[n] may be calculated using equation 1 above, where, in this case, S₁[n] and S₀[n] are expressed as S₁[n]=U[n−1]exp(F[n])Y and S₀[n]=U[n−1]exp(−F[n])Y respectively. Then, applying equation 1, q[n] can be expressed as:

q[n]=M(H[n]S₁[n])−M(H[n]S₀[n])

where, as above, the matrix H[n] is the channel matrix at a time, frequency, or joint time/frequency instance n and M(•) is a metric function. In these expressions the matrix Y is a fixed matrix and is expressed as

$$Y = [ \begin{matrix}{I}_{{N}_{s}} \\ {0}_{( {N}_{l} - {N}_{s} ) \times {N}_{s}}\end{matrix} ] ,$$

where I is the identity matrix and 0 is a matrix that contains only zeros. The matrix F for time instance n is given by

$$F [ n ] = [ \begin{matrix}0 & - {G}^{H} [ n ] \\ G [ n ] & 0\end{matrix} ]$$

where matrix G is a random matrix, and U is a unitary matrix. Matrices G and U are described in greater detail below. If the direction of maximizing the selected metric is toward S₁[n], then the feedback bit b[n]=1 is sent to the transmitter. Otherwise, the feedback bit b[n]=−1 is sent to transmitter.

Various metrics can be considered depending on the MIMO mode, rank or channel condition. The metric function can be defined as Frobenius norm of the effective channel, that is

M(\tilde{H})=∥\tilde{H}∥_{F}.

Alternatively, the metric function can be a MSE of a corresponding MMSE receiver, that is

$$M ( \tilde{H} ) = - trace ( {( {\tilde{H}}^{H} \tilde{H} + \frac{1}{SNR} I )}^{- 1} )$$

$$or$$

$$M ( \tilde{H} ) = - trace ( {( \tilde{H} {\tilde{H}}^{H} + \frac{1}{SNR} I )}^{- 1} ) .$$

The metric function can also be a mean-square error (MSE) or measure of any other types of receivers including a minimum mean square error based on successive interference cancellation (MMSE-SIC) or QR Decomposition and M-algorithm based Maximum likelihood Detection (QRM-MLD). Other metrics such as channel capacity can also be used, such as

$$M ( \tilde{H} ) = {log}_{2} det ( {\tilde{H}}^{H} \tilde{H} + \frac{1}{ρ} I )$$

$$or$$

$$M ( \tilde{H} ) = {log}_{2} det ( \tilde{H} {\tilde{H}}^{H} + \frac{1}{ρ} I )$$

where ρ is SNR or SINR. Any combination of these metrics for different ranks can also be used. For example for a rank-1 operation, the metric function can use the Frobenius norm. For ranks higher than 1, the metric function can use a MSE of a MMSE receiver, or vice versa.

At each feedback instance, the random matrix G[n] may be generated using a bounded uniform distribution zero mean random number generator. A possible procedure for this is the following.

Each entry of matrix G is generated using a uniform distribution random number between −1 and 1. The generated random numbers with uniform distribution are normalized to have norm equal to one. The normalized uniform random numbers are then scaled by a scalar γ. The scalar γ is the step size for adaptive update and process. The parameter γ in matrix G can be static or dynamic. The parameter γ may be adaptively adjusted according to speed or Doppler shift associated with a moving unit, e.g. 200 or 222. The value of γ may be adjusted in such ways: γ may increase or decrease if speed or Doppler frequency increases or decreases, respectively. Several values of step size or γ may be designed and several speed segments or Doppler segments can be designed. Each value of step size or γ corresponds to a proper speed or Doppler segment. Mobile units can measure the speed or Doppler and find the corresponding step size or γ and feed it back to a base station or Node B. A base station or Node B can also measure the speed or Doppler shift, find a proper step size or γ and send γ to the mobile units. Other matrix types can also be used for G such as a matrix with independent and identical distribution (i.i.d.) complex Gaussian distributions of zero mean and variance α².

The matrix G has the dimension of Nₜ−Nₛ by Nₛ and is known to both transmitter and receiver. In the embodiment shown in FIG. 3, as described above, matrix G is synchronously generated in both transmitter 200 and receiver 222. Alternatively, matrix G may be preconfigured and stored in a memory in both transmitter 200 and receiver 222. In another alternative, the information in matrix G can be generated in, for example, transmitter 200, multiplexed with data at multiplexer 202 and sent to receiver 222. An index to matrix G can be fed back to a transmitter or base station from a receiver or UE.

The precoding matrix T may be updated as follows. Define matrix U[n] as a unitary matrix generated by concatenating the precoding matrix T[n] and a matrix E[n] at time instance n:

U[n]=[T[n]E[n]].

E[n] is a matrix which contains columns as an orthonormal basis of an orthogonal complement of the matrix T[n], so that U[n] is a unitary matrix. The precoding matrix for the next time instance, n+1, can be determined by

T[n+1]=U[n]exp(b[n+1]F[n+1])Y

Alternatively, if T[n] and G[n+1] are given, a computation of T[n+1] may proceed as follows. If the feedback bit b[n+1] is 1, the matrix G[n+1] is decomposed or if the feedback bit b[n+1] is −1 the matrix −G[n+1] is decomposed. In either case the decomposition is done using singular value decomposition (SVD), according to:

G[n+1]=V₂ΘV₁^{H}

The matrix Θ is a diagonal matrix such that Θ=diag(θ₁, θ₂, . . . , θ_{N}_{ₛ}). The variables θᵢ, i=1, 2, . . . , Nₛ are the principal angles between the subspaces T[n] and T[n+1]. The values of sin(θᵢ) and cos(θᵢ) for 1, 2, . . . Nₛ are computed. Diagonal matrices C and S are constructed according to the expressions C=diag(cos θ₁, cos θ₂, cos θ_{N}_{ₛ}) and S=diag(sin θ₁, sin θ₂, . . . , sin θ_{N}_{ₛ}). The matrix U[n] is obtained using U[n]=[T[n]E[n]] as described above. The updated matrix T[n+1] is computed as:

$$T [ n + 1 ] = U [ n ] [ \begin{matrix}{V}_{1} C \\ {V}_{2} S\end{matrix} ] .$$

This method can be generalized to the use of more than one random matrix or more than one set of random matrices and signaling with more than one bit.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method of generating feedback in multiple-input/multiple-output (MIMO) communications, comprising:
receiving a first signal transmitted using a precoding matrix;
determining a value of a metric associated with the first signal;
calculating a metric function from the value of a metric;
determining an update to the precoding matrix which optimizes the metric, the update being calculated from the metric function;
updating the precoding matrix using the update; and
receiving a second signal transmitted using the updated precoding matrix.

2. The method of claim 1, further comprising updating the precoding matrix for more than one frequency band.

3. The method of claim 1, wherein optimizing the metric comprises at least one of:
maximizing a received power;
maximizing a signal-to-noise-ratio;
maximizing a signal-to-interference-ratio;
maximizing a signal-to-noise-and-interference ratio (SINR);
maximizing a channel capacity;
maximizing a reception rate;
minimizing a received interference level;
minimizing a mean square error (MSE); and
minimizing a bit error rate (BER).

4. The method of claim 1, wherein determining an update comprises calculating an update q[n] according to the equation [n]=M(H[n]S₁[n])−M(H[n]S₀[n]), where M( ) is the metric function, H is a channel matrix and S₁ and S₀ are matrices representing signal flows.

5. The method of claim 1, wherein determining an update comprises determining a single bit.

6. The method of claim 1, wherein determining an update comprises determining more than one bit.

7. The method of claim 5, comprising calculating the single bit using the equation
s[n]=sign{∥H[n+1]T⁺[n+1]∥_{F}²−∥H[n+1]T⁻[n+1]∥_{F}²}
where H[n+1] is a channel matrix, T⁺[n+1] and T⁻[n+1] are two possible updated precoding matrices, and ∥ ∥_{F} indicates a Frobenius norm.

8. The method of claim 7, comprising calculating the updated precoding matrices from the equations
T⁺[n+1]=T[n]+v∥T[n]∥U
and
T⁻[n+1]=T[n]−v∥T[n]∥U
where T[n] is a precoding matrix not yet updated, U is a random perturbation matrix and v is an update step size.

9. The method of claim 1, wherein determining an update comprises generating at least one set of set of random matrices.

10. The method of claim 9, wherein a combination of updated precoding matrix and random matrix to be used is signaled with one or more bits.

11. The method of claim 1, wherein determining an update comprises:
defining current and updated precoding matrices as points in a Grassmann manifold; and
determining a signal flow in the manifold between the points.

12. The method of claim 11, comprising computing a feedback sign bit based on a direction that optimizes the metric.

13. The method of claim 12, wherein computing the feedback sign bit b[n] comprises evaluating equation b[n]=sign (q[n]), where q[n] is an effective channel measurement for the direction that optimizes the metric.

14. The method of claim 13, comprising determining q[n] from the equation q[n]=M(H[n]S₁[n])−M(H[n]S₀[n]), where
H[n] is a channel matrix;
M(•) is a metric function;
S₁[n]=U[n−1]exp(F[n])Y;
S₀[n]=U[n−1]exp(−F[n])Y;
U is a unitary matrix;
$$Y = [ \begin{matrix}{I}_{{N}_{s}} \\ {0}_{( {N}_{t} - {N}_{s} ) \times {N}_{s}}\end{matrix} ] ;$$
I_{N}_{ₛ} is an identity matrix;
0_{(N}_{ₜ}_{-N}_{ₛ}_{)×N}_{ₛ} is a matrix containing only zeros;
$$F [ n ] = [ \begin{matrix}0 & - {G}^{H} [ n ] \\ G [ n ] & 0\end{matrix} ] ; and$$
G is a random matrix.

15. The method of claim 14, wherein the metric function is calculated using one of the equations
$$M = ( \tilde{H} ) = - trace ( {( {\tilde{H}}^{H} \tilde{H} + \frac{1}{SNR} I )}^{- 1} )$$
$$and$$
$$M ( \tilde{H} ) = {log}_{2} det ( {\tilde{H}}^{H} \tilde{H} + \frac{1}{ρ} I ) .$$

16. The method of claim 14, comprising generating the random matrix using independent and identical distribution (i.i.d.) complex Gaussian distributions of zero mean and a variance.

17. The method of claim 14, comprising generating the random matrix using a uniform distribution of random number between −1 and 1.

18. The method of claim 17, comprising:
normalizing the random numbers to have norm equal to 1; and
scaling the normalized numbers by a scalar.

19. The method of claim 18, wherein the scalar is static.

20. The method of claim 18, comprising adjusting the scalar dynamically.

21. The method of claim 14, comprising adjusting the random matrix based on at least one of:
a speed; and
a Doppler shift.

22. The method of claim 9 comprising synchronously generating the at least one set of random matrices at a transmitter and at a receiver.

23. The method of claim 9 comprising receiving the at least one set of random matrices multiplexed with data.

24. The method of claim 9 comprising preconfiguring the at least one set of random matrices and storing the at least one set of matrices in memory in a transmitter and in a receiver.

25. The method of claim 1, wherein updating the precoding matrix T[n] comprises:
creating a matrix U[n] by concatenating the precoding matrix and a matrix which contains columns as an orthonormal basis of an orthogonal complement of the matrix, thereby making U[n] unitary; and
calculating an updated precoding matrix T[n+1] using the equation T[n+1]=U[n]exp(b[n+1]F[n+1])Y, where
b[n+1] is a feedback sign bit;
$$Y = [ \begin{matrix}{I}_{{N}_{s}} \\ {0}_{( {N}_{t} - {N}_{s} ) \times {N}_{s}}\end{matrix} ] ;$$
I_{N}_{ₛ} is an identity matrix;
0_{(N}_{ₜ}_{-N}_{ₛ}_{)×N}_{ₛ} is a matrix containing only zeros;
$$F [ n ] = [ \begin{matrix}0 & - {G}^{H} [ n ] \\ G [ n ] & 0\end{matrix} ] ; and$$
G is a random matrix.

26. The method of claim 1, wherein updating the precoding matrix T[n] comprises:
decomposing a known random matrix G according to the equation G[n+1]=V₂ΘV₁^{H}, where Θ is a diagonal matrix comprising Ns elements θ₁, θ₂, . . . , θ_{N}_{ₛ}, Nₛ being the dimensionality of a subspace of the channel matrix;
defining diagonal matrix C as C=diag(cos θ₁, cos θ₂, . . . , cos θ_{N}_{ₛ});
defining diagonal matrix S as S=diag(sin θ₁, sin θ₂, . . . , sin θ_{N}_{ₛ});
creating a unitary matrix U[n] by concatenating the precoding matrix and a matrix which contains columns as an orthonormal basis of an orthogonal complement of the precoding matrix; and
calculating an updated precoding matrix T[n+1] using the equation
$$T [ n + 1 ] = U [ n ] [ \begin{matrix}{V}_{1} C \\ {V}_{2} S\end{matrix} ] .$$

27. A wireless transmit/receive unit (WTRU) configured for providing feedback in multiple-input/multiple-output (MIMO) communications comprising:
a transmitter;
a receiver; and
a processor;
the receiver configured to
receive a first signal transmitted using a precoding matrix, and
receive a second signal transmitted using an updated precoding matrix;
the processor configured to:
determine a value of a metric associated with the first signal,
calculate a metric function from the value of the metric;
determine, using the metric function, an update to the precoding matrix which optimizes the metric;
the transmitter configured to transmit the optimizing update.

28. The WTRU of claim 27, wherein the processor is configured to optimize the metric by performing at least one of:
maximizing a received power;
maximizing a signal-to-noise-ratio;
maximizing a signal-to-interference-ratio;
maximizing a signal-to-noise-and-interference ratio (SINR);
maximizing a channel capacity;
maximizing a reception rate;
minimizing a received interference level;
minimizing a mean square error (MSE); and
minimizing a bit error rate (BER).

29. The WTRU of claim 27, wherein the transmitter is configured to determine the update by calculating an update q[n] according to the equation q[n]=M(H[n]S₁[n])−M(H[n]S₀[n]), where MO is the metric function, n represents a time instance, H is a channel matrix and S₁ and S₀ are matrices representing signal flows.

30. The WTRU of claim 27, wherein the processor is configured for determining the update by determining a single bit.

31. The WTRU of claim 30, wherein the processor is configured to calculate the single bit using the equation
s[n]=sign{∥H[n+1]T⁺[n+1]∥_{F}²−∥H[n+1]T⁻[n+1]∥_{F}²}
where H[n+1] is a channel matrix, T⁺[n+1] and T⁻[n+1] are two possible updated precoding matrices; and ∥ ∥_{F} indicates a Frobenius norm.

32. The WTRU of claim 31, wherein the processor is configured to calculate the updated precoding matrices T⁺[n+1] and T⁻[n+1] from the equations
T⁺[n+1]=T[n]+v∥T[n]∥U
and
T⁻[n+1]=T[n]−v∥T[n]∥U
where T[n] is a precoding matrix not yet updated, U is a random perturbation matrix and v is an update step size.

33. The WTRU of claim 27, wherein the processor is configured to determine the update using a random matrix.

34. The WTRU of claim 27, wherein the processor is configured to determine the update by determining a signal flow between points representing current and updated precoding matrices in a Grassmann manifold

35. The WTRU of claim 34 wherein the processor is configured to compute a feedback sign bit based on a direction that optimizes the metric.

36. The WTRU of claim 35 wherein the processor is configured to compute the feedback sign bit b[n] by evaluating the equation b[n]=sign (q[n]), where q[n] is an effective channel measurement for the direction that optimizes the metric.

37. The WTRU of claim 36 wherein the processor is configured to determine q[n] from the equation q[n]=M(H[n]S₁[n])−M(H[n]S₀[n]), where
H[n] is the channel matrix at time instance n;
M is a metric function;
S₁[n]=U[n−1]exp(F[n])Y;
S₀[n]=U[n−1]exp(−F[n])Y;
U is a unitary matrix;
$$Y = [ \begin{matrix}{I}_{{N}_{s}} \\ {0}_{( {N}_{t} - {N}_{s} ) \times {N}_{s}}\end{matrix} ] ;$$
I_{N}_{ₛ} is an identity matrix;
0_{(N}_{ₜ}_{-N}_{ₛ}_{)×N}_{ₛ} is a matrix containing only zeros;
$$F [ n ] = [ \begin{matrix}0 & - {G}^{H} [ n ] \\ G [ n ] & 0\end{matrix} ] ; and$$
G is a random matrix.

38. The WTRU of claim 37, wherein the processor is configured to calculate the metric function using one of the equations
$$M = ( \tilde{H} ) = - trace ( {( {\tilde{H}}^{H} \tilde{H} + \frac{1}{SNR} I )}^{- 1} )$$
$$and$$
$$M ( \tilde{H} ) = {log}_{2} det ( {\tilde{H}}^{H} \tilde{H} + \frac{1}{ρ} I ) .$$

39. The WTRU of claim 37, wherein the processor is configured to determine q[n] when the random matrix is generated with independent and identical distribution (i.i.d.) complex Gaussian distributions of zero mean and a variance.

40. The WTRU of claim 37, wherein the processor is configured to determine q[n] when the random matrix is generated using a uniform distribution of random numbers between −1 and 1.

41. The WTRU of claim 33 wherein the receiver is configured to receive the random matrix multiplexed with data and the processor is configured to determine q[n] from the random matrix when so received.

42. The WTRU of claim 33 comprising circuitry for generating the random matrix synchronously with another generator.

43. The WTRU of claim 33 comprising a memory configured for storing a set of preconfigured random matrices.

44. A processor for updating a precoding matrix, comprising:
a unitary module configured to generate a unitary matrix;
a randomizing module configured to generate a random matrix; and
a precoding module configured to receive the unitary matrix and random matrix and generate therefrom an updated precoding matrix.

45. The processor of claim 44, wherein the precoding module is configured to generate the updated precoding matrix using the equation T[n+1]=U[n]exp(b[n+1]F[n+1])Y where
b[n+1] is a feedback sign bit,
$$Y = [ \begin{matrix}{I}_{{N}_{s}} \\ {0}_{( {N}_{t} - {N}_{s} ) \times {N}_{s}}\end{matrix} ] ,$$
I_{N}_{ₛ} an identity matrix;
0_{(N}_{ₜ}_{-N}_{ₛ}_{)×N}_{ₛ} a matrix containing only zeros;
$$F [ n ] = [ \begin{matrix}0 & - {G}^{H} [ n ] \\ G [ n ] & 0\end{matrix} ] ;$$
U[n] is a unitary matrix at time interval n generated by the unitary module; and
G[n] is a random matrix.

46. The processor of claim 45, wherein the precoding module is configured to update the precoding matrix by
decomposing the random matrix G according to the equation G[n+1]=V₂ΘV₁^{H}, where Θ is a diagonal matrix comprising Nₛ elements θ₁, θ₂, . . . , θ_{N}_{ₛ}, Nₛ being Nₛ being the dimensionality of a subspace of the channel matrix;
generating diagonal matrix C as C=diag(cos θ₁, cos θ₂, . . . , cos θ_{N}_{ₛ});
generating diagonal matrix S as S=diag(sin θ₁, sin θ₂, . . . , sin θ_{N}_{ₛ}); and
calculating an updated precoding matrix T[n+1] using the equation
$$T [ n + 1 ] = U [ n ] [ \begin{matrix}{V}_{1} C \\ {V}_{2} S\end{matrix} ] .$$

47. The processor of claim 44, wherein the unitary module is configured to generate the unitary matrix by concatenating a current precoding matrix and a matrix which contains columns as an orthonormal basis of an orthogonal complement of the current precoding matrix.

48. The processor of claim 44, wherein the randomizing module is configured for generating the random matrix using independent and identical distribution (i.i.d.) complex Gaussian distributions of zero mean and a variance.

49. The processor of claim 44, wherein the randomizing module is configured for generating the random matrix using a uniform distribution of random numbers between −1 and 1.

50. The processor of claim 49, wherein the randomizing module is configured for normalizing the random numbers to have norm equal to 1 and scaling the normalized numbers by a scalar.

51. The processor of claim 50, wherein the randomizing module is configured to use a static scalar.

52. The processor of claim 50 wherein the randomizing module is configured to use a scalar which is dynamically adjusted.

53. The processor of claim 52, wherein the scalar is dynamically adjusted according to a speed or a Doppler shift associated with a moving unit.

54. The processor of claim 44, wherein the randomizing module is configured for synchronously generating the random matrix with another generator.

55. The processor of claim 44 further comprising a multiplexer configured for multiplexing the random matrix with data.

56. The processor of claim 44, further comprising rank adaptation circuitry configured to receive rank adaptation information and convey the information to the precoding module, to be used in the updating of the precoding matrix.

57. The processor of claim 53 further comprising Doppler adjustment circuitry configured for receiving information on the speed or Doppler shift and conveying the information to the randomizing module, for use in generating the random matrix.

58. The method of claim 25, wherein determining an update comprises generating at least one set of random matrices.

59. The method of claim 58 wherein a combination of an updated precoding matrix and a random matrix to be used is signaled with one or more bits.

60. The method of claim 4 wherein n indicates a time interval, a frequency interval, a subcarrier, a frequency band, a resource block, or a resource block group in any combination.

61. The method of claim 14 wherein n indicates a time interval, a frequency interval, a subcarrier, a frequency band, a resource block, or a resource block group in any combination.

62. The method of claim 25 wherein n indicates a time interval, a frequency interval, a subcarrier, a frequency band, a resource block, or a resource block group in any combination.
